(19) United States
(12) Patent Application Publication
(10) Pub. No.: US 2020/0328820 A1
(43) Pub. Date: Oct. 15, 2020

(54) METHOD FOR RECEIVING AND PROCESSING SOUND WAVE OF APPLICATION IN COMPUTING DEVICE

(71) Applicant: ONNURIDMC INC., Seoul (KR)

(72) Inventor: Tae Hyun KIM, Seoul (KR)

(21) Appl. No.: 16/886,789

(22) Filed: May 29, 2020

Related U.S. Application Data
(63) Continuation of application No. PCT/KR2017/013789, filed on Nov. 29, 2017.

(30) Foreign Application Priority Data
Nov. 29, 2017 (KR) 10-2017-0161419

(51) Int. Cl. H04B 11/00; G10L 19/018

(52) U.S. Cl. CPC H04B 11/00; G10L 19/018

(57) ABSTRACT

One embodiment of the present invention provides a method for receiving and processing a sound wave of an application executed in a computing device, the method comprising: a step in which a first application receives a sound wave signal including sound wave identification information (ID); a step in which the first application extracts the sound wave ID from the received sound wave signal; a step in which, if the sound wave ID is not a sound wave ID related to the first application, the first application obtains application identification information (“App ID”) of a second application which should receive the extracted sound wave ID; and a step in which the first application transfers the sound wave ID to the second application on the basis of the App ID.

### TECHNICAL FIELD

The present disclosure relates to a method for receiving and processing a sound wave in a computing device, and more particularly, to a method for adjusting sound wave receiving operations when a plurality of applications in a computing device receive sound wave signals, and receiving and processing the sound wave signals.

The present disclosure was supported by National Research and Development Business as follows:

[National Research and Development Business supporting the present disclosure]

[Project Number] 2017-0-01507

[Related Department] Ministry of Science and ICT

[Research Management Specialized Agency] Institute for Information & Communications Technology Promotion (IITP)

[Research Business Title] Smart Media Technology Research and Business Development (R&BD) Supporting Business

[Research Project Title] Development of Technology of Extended Second Screen Sound Wave For Transmitting VOD Reproduction Command To Set-top Box

[Contribution Rate] 1/1

[Lead Institute] sound.ly, Inc.

[Research Period] Jun. 1, 2017-Dec. 31, 2018

### BACKGROUND ART

As mobile devices such as smartphones are widely used in recent years, sound wave communication methods utilizing an audio interface embedded in a mobile device, that is, a speaker and a microphone, are commercialized. For example, when a non-audible sound wave containing specific information is inserted into a television (TV) broadcasting program, and is broadcasted to a viewer, a mobile device owned by the viewer receives the non-audible sound wave, and based on this, provides a content such as a customized advertisement, etc. to the viewer.

There may be a plurality of applications installed and executed in a mobile device to receive and process a sound wave signal and to provide a content. However, if various reception modules perform respective sound wave receiving operations through the plurality of applications, there may be problems that battery consumption increases and a conflict occurs between the receiving operations.

Accordingly, there is a need for a method for managing sound wave receiving operations of a mobile device as efficiently as possible, by adjusting sound wave receiving operations of applications when a plurality of applications performing sound wave receiving operations are installed.

### DETAILED DESCRIPTION OF THE PRESENT DISCLOSURE

### Technical Objects

According to an embodiment of the present disclosure, there is provided a method for receiving and processing a sound wave, whereby, when a sound wave signal received by a first application includes a sound wave ID related to a second application, the sound wave ID is transmitted to the second application.

### Technical Solving Means

According to an embodiment of the present disclosure, there is provided a method for receiving and processing a sound wave of an application which is executed in a computing device, the method including: receiving, by a first application, a sound wave signal including sound wave identification information (ID); extracting, by the first application, the sound wave ID from the received sound wave signal; when the sound wave ID is not a sound wave ID related to the first application, obtaining, by the first application, application identification information (“app ID) of a second application which should receive the extracted sound wave ID; and, based on the app ID, transmitting, by the first application, the sound wave ID to the second application.

According to an embodiment of the present disclosure, there is provided a method for receiving and processing a sound wave of an application which is executed in a computing device, the method including: receiving, by a first application, a sound wave signal including a sound wave ID; extracting, by the first application, the sound wave ID from the received sound wave signal; when the sound wave ID is not a sound wave ID related to the first application, obtaining, by the first application, application identification information (“app ID) of a second application which should receive the extracted sound wave ID, and content information related to the extracted sound wave ID; and transmitting, by the first application, the content information to the second application based on the app ID.

According to an embodiment of the present disclosure, there is provided a computer readable recording medium having a program recorded thereon to execute the method for receiving and processing the sound wave described above in a computer.

### Advantageous Effects

According to an embodiment of the present disclosure, when a sound wave signal received by the first application includes a sound wave ID related to the second application, the first application is configured to transmit the sound wave ID to the second application. Therefore, there is an advantage that sound wave receiving operations can be efficiently managed without substantially reducing the number of sound wave receiving operations of each application.

### BRIEF DESCRIPTION OF THE DRAWINGS

FIG. 1 is a view provided to explain an overall system for receiving and processing a sound wave of an application in a computing device according to an embodiment of the present disclosure;

FIG. 2 is a view provided to explain an operation of receiving and processing a sound wave of an application according to a first embodiment;

FIG. 3 is a view provided to explain an operation of receiving and processing a sound wave of an application according to a second embodiment;

FIG. 4 is a view provided to explain an operation of receiving and processing a sound wave of an application according to a third embodiment;

FIG. 5 is a view provided to explain an operation of receiving and processing a sound wave of an application according to a fourth embodiment;

FIGS. 6A to 6C are views provided to explain a sound wave receiving operating period of an application according to an embodiment;

FIG. 7 is a view provided to explain a method for adjusting sound wave receiving operations between applications;

FIG. 8 is a view provided to explain an alternative method for adjusting sound wave receiving operations between applications; and

FIG. 9 is a view provided to explain another alternative method for adjusting sound wave receiving operations between applications.

### BEST MODE FOR EMBODYING THE INVENTION

Exemplary embodiments will now be described more fully with reference to the accompanying drawings to clarify aspects, other aspects, features and advantages of the present disclosure. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the present disclosure to those of ordinary skill in the art. In the following description, it will be understood that when an element is referred to as being “on” another element, the element may be directly on another element or there may be a third element therebetween.

The terms used in the following descriptions are just for explaining embodiments and are not intended to limit the present disclosure. As used herein, the singular forms are intended to include the plural forms as well, unless the context clearly indicates otherwise. It will be understood that the terms “comprises” and/or “comprising,” when used in this specification, do not preclude the presence or addition of one or more other components.

The terms “unit,” “module,” “board,” “block,” etc. used in the description of this application to indicate a component of the present disclosure refer to a unit for processing at least one function or operation, and may be implemented by hardware, software, or a combination of hardware and software.

Hereinafter, the present disclosure will be described in greater detail with reference to the accompanying drawings. In describing specific embodiments, various specific features are described to assist in a detailed description and a comprehensive understanding of the present invention. However, it is apparent that the exemplary embodiments can be carried out by those of ordinary skill in the art without those specifically defined features. In the description of exemplary embodiments, certain detailed explanations of portions which are well known and have nothing to do with the present disclosure are omitted when it is deemed that they may unnecessarily obscure the essence of the present disclosure.

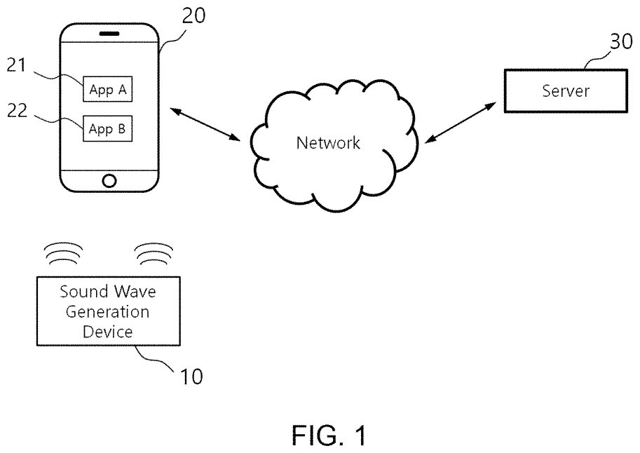

FIG. 1 is a view provided to explain an overall system for receiving and processing a sound wave of an application in a computing device according to an embodiment of the present disclosure.

Referring to the drawing, a sound wave generation device 10 may transmit a sound wave signal including sound wave identification information (ID), and a mobile device 20 around the sound wave generation device 10 may receive the sound wave signal and may extract the sound wave ID therefrom.

In a preferred embodiment, the sound wave generation device 10 may be a certain device that can transmit a sound wave signal. For example, the sound wave generation device 10 may be a TV system or an audio system in a house, a store, or a theater. In an embodiment, the sound wave signal transmitted from the sound wave generation device 10 includes identification information (hereinafter, referred to as “sound wave identification information (ID)”) which is formed of digital bits of a predetermined length. The sound wave identification information is formed of digital bits of a predetermined length, distinct from other sound wave identification information.

In an embodiment, the sound wave ID may be inserted into a non-audible band of the sound wave signal. The non-audible band refers to a frequency band that cannot be heard by human hearing, and may include a frequency of a band ranging from 18 to 24 KHz.

The term “sound wave” used in the description of the present disclosure refers to a vibration of a material that propagates through a medium (air) and can be heard by human hearing, and may be interchangeably used with the term “sound” or “audio” in the description as long as there is no need to distinguish them.

A method for injecting a sound wave ID formed of digital bits of a predetermined length into a sound wave signal is well known in the related-art technology. For example, a sound wave of a non-audible band may be generated by a sound wave generator, and a sound wave ID may be injected into the generated non-audible band sound wave. A sound wave signal including a sound wave ID may be generated by modulating the sound wave ID which is digital data by at least one of various modulations methods, such as amplitude shift keying (ASK), frequency shift keying (FSK), Chirp Modulation or phase shift keying (PSK), and then loading the sound wave ID on a non-audible sound wave.

When the sound wave generation device 10 transmits the sound wave signal, the mobile device 20 in the vicinity of the sound wave generation device 10 may receive the sound wave signal. The mobile device 20 may be, for example, one of computing devices capable of communication, such as a cellular phone, a smartphone, a tablet PC, or a notebook. In an alternative embodiment, a computing device such as a personal computer (PC), etc. may be substituted for the mobile device 20. In the following description, embodiments in which the present disclosure is applied to the mobile device 20 will be described, but the present disclosure is not limited to the mobile device 20 and can be applied to various types of computing devices described above.

The mobile device 20 may include hardware such as a microphone, an analog-digital converter (ADC), a signal extractor, a computer processor (not shown), and a memory, and software such as programs to receive the sound wave signal and to extract the sound wave ID from the sound wave signal.

A plurality of applications 21, 22 may be installed and executed in the mobile device 20. Each of the plurality of applications 21, 22 may receive the sound wave signal, may extract the sound wave ID from the sound wave signal, and may perform a predetermined operation according to the extracted sound wave ID.

The applications 21, 22 may perform their respective sound wave receiving operations at predetermined intervals or randomly. However, when the first application 21 performs the sound wave receiving operation, it may not be guaranteed that a sound wave signal that the first application 21 should necessarily receive is currently transmitted from the sound wave generation device 10. For example, the sound wave generation device 10 currently transmits a sound wave signal with a sound wave ID inserted thereinto that the second application 22 should receive, but the first application 21 may perform the sound wave receiving operation. In this case, in an embodiment, the first application 21 receives the sound wave signal and extracts the sound wave ID, and may identify that the sound wave ID is a sound wave ID that the second application 22 should receive.

In an embodiment, the first application 21 may transmit the extracted sound wave ID to a server 30 through a network in order to identify the sound wave ID, and may receive, from the server 30, application identification information of an application that should receive the corresponding sound wave ID. In another embodiment, the first application 21 may receive, from the server 30, the application identification information of the application that should receive the corresponding sound wave ID, and content information corresponding to the corresponding sound wave ID. Herein, the “network” may include one of various wired or wireless communication networks, such as Internet, a mobile communication network, a wide area network (WAN), a local area network (LAN), Bluetooth, etc. In addition, the “content information” may refer to certain data or information pre-stored according to a sound wave ID. For example, the content information may be a URL of a specific web site, or may be an image, a text, or multimedia information, and may vary according to a specific embodiment of the present disclosure.

Thereafter, the first application 21 may transmit the sound wave ID or the content information corresponding to the sound wave ID to the second application 22. The second application 22 may receive the sound wave ID from the first application 21, and then may perform a predetermined operation according to the sound wave ID. For example, the second application may transmit the sound wave ID to the server 30 and then may receive the content information from the server 30.

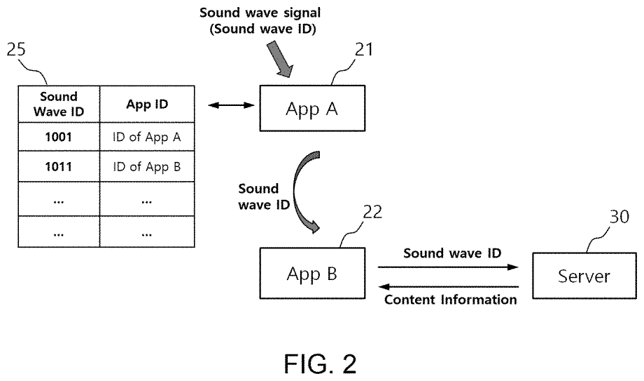

FIGS. 2 to 5 illustrate various embodiments in which an application receives a sound wave signal and extracts a sound wave ID, and then notifies another application of this. In the drawings, a first application App A 21 and a second application App B 22 may be applications that are installed and executed in the mobile device 20, and the server 30 may be communicably connected with the mobile device 20 through a network. In addition, it is assumed that the sound wave generation device 10 transmits a sound wave signal including a sound wave ID, and in this case, the first application 21 of the mobile device 20 performs a sound wave receiving operation.

FIG. 2 illustrates an operation of receiving and processing a sound wave of an application according to a first embodiment. In the first embodiment, a method for receiving and processing a sound wave of an application which is executed in a computing device may include: receiving, by a first application, a sound wave signal including sound wave identification information (ID); extracting, by the first application, the sound wave ID from the received sound wave signal; when the sound wave ID is not a sound wave ID related to the first application, obtaining, by the first application, application identification information (“app ID) of a second application which should receive the extracted sound wave ID; and, based on the app ID, transmitting, by the first application, the sound wave ID to the second application.

Specifically, referring to FIG. 2, the first application 21 of the mobile device 20 receives a sound wave signal including a sound wave ID through the sound wave receiving operation, and extracts the sound wave ID from the received sound wave signal. Thereafter, the first application 21 determines whether the extracted sound wave ID is a sound wave ID related to the first application. In an embodiment, the first application 21 may perform such determination based on mapping information 25.

FIG. 2 illustrates exemplary mapping information 25. The mapping information 25 may include a plurality of sound wave IDs and identification information of applications (hereinafter, referred to as “app ID”) related to the respective sound wave IDs. The mapping information 25 may be stored in a certain storage means that is accessible by the mobile device 20. In an embodiment, the mapping information 25 may be stored in the form of a lookup table or a database.

The app ID may be identification information for distinguishing one application from other applications, and for example, may be referred to as “process ID,” “package name,” “class name,” etc. in the Android OS. Hereinafter, the “app ID” will be used for convenience of explanation.

In an embodiment, the sound wave ID is formed of a series of bit strings of a predetermined number of bits. In the illustrated embodiment, the sound wave ID is 4 bits long for easy explanation of the present disclosure, but the number of bits may vary according to a specific embodiment.

Referring to the mapping information 25 illustrated, if the sound wave ID extracted by the first application 21 is “1001,” the first application 21 may determine that the extracted sound wave ID is the sound wave ID related to the first application, and may perform a subsequent operation corresponding to the corresponding sound wave ID. For example, the first application 21 may transmit the sound wave ID to the server 30, and may receive specific content information from the server 30.

When the sound wave ID extracted by the first application 21 is not the sound wave ID related to the first application 21, the first application 21 may obtain an app ID of an application related to the extracted sound wave ID.

For example, if the sound wave ID extracted by the first application 21 is “1011,” the first application 21 may determine that the sound wave ID is a sound wave ID related to the second application 22, based on the mapping information 25, and may obtain an app ID of the second application 22. Thereafter, the first application 21 may transmit the sound wave ID to the second application 22 by using the app ID of the second application 22. Transmitting data between applications in the mobile device 20 is well known in the related-art technology. For example, if the mobile device 20 operates in the Android OS, the first application 21 may transmit the sound wave ID to the second application 22 by using functions of Intent-Broadcast Receiver, Binder, etc. or by using Inter Process Communication (IPC) technology such as Android Interface Definition Language (AIDL).

When the second application 22 receives the sound wave ID from the first application 21, the second application 22 may perform a predetermined operation according to the sound wave ID. For example, the second application 22 may transmit the sound wave ID to the server 30, and the server 30 may transmit content information corresponding to the sound wave ID to the second application 22. Herein, the “content information” may be certain data or information pre-stored according to a sound wave ID. For example, the content information may be a URL of a specific web site, or may be an image, a text, or multimedia information, and may vary according to a specific embodiment of the present disclosure.

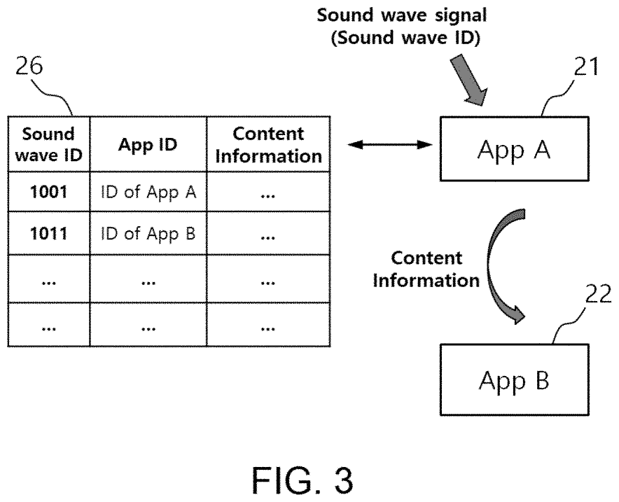

FIG. 3 illustrates an operation of receiving and processing a sound wave of an application according to a second embodiment. According to the second embodiment, a method for receiving and processing a sound wave of an application which is executed in a computing device may include: receiving, by a first application, a sound wave signal including a sound wave ID; extracting, by the first application, the sound wave ID from the received sound wave signal; when the sound wave ID is not a sound wave ID related to the first application, obtaining, by the first application, application identification information (“app ID) of a second application which should receive the extracted sound wave ID, and content information related to the extracted sound wave ID; and transmitting, by the first application, the content information to the second application based on the app ID.

Specifically, referring to FIG. 3, the first application 21 of the mobile device 20 may receive a sound wave signal including a sound wave ID, and may extract the sound wave ID from the received sound wave signal. The first application 21 determines whether the extracted sound wave ID is a sound wave ID related to the first application. In the illustrated second embodiment, the first application 21 may perform such determination based on mapping information 26.

FIG. 3 illustrates exemplary mapping information 26 of the second embodiment. The mapping information 26 includes a plurality of sound wave IDs, app IDs related to the respective sound wave IDs, and content information related to the respective sound wave IDs. The mapping information 26 may be stored in a certain storage means that is accessible by the mobile device 20. In an embodiment, the mapping information 26 may be stored in the form of a lookup table or a database.

Compared to the mapping information 25 of FIG. 2, the mapping information 26 of FIG. 3 further includes the content information related to the respective sound wave IDs. Accordingly, the first application 21 may obtain not only an app ID but also content information. For example, if the sound wave ID extracted by the first application 21 is “1011,” the first application 21 may determine that the sound wave ID is the sound wave ID related to the second application 22, based on the mapping information 26, and may obtain the app ID of the second application 22, and also, the first application 21 may obtain content information associated with the sound wave ID, based on the mapping information 26.

In an embodiment, the first application 21 may transmit the content information to the second application 22. In another embodiment, the first application 21 may transmit the sound wave ID and the content information to the second application 22. Thereafter, the second application 22 may output the received content information through a display or a speaker of the mobile device 20, for example. The method for transmitting data between applications and the meaning of the content information have been described with reference to FIG. 2, and thus a description thereof is omitted.

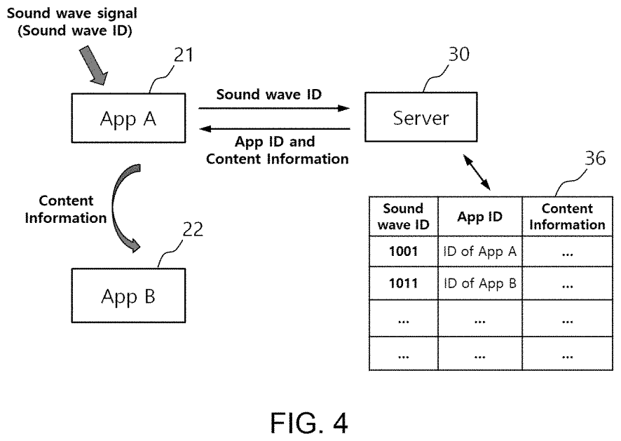

FIG. 4 illustrates an operation of receiving and processing a sound wave of an application according to a third embodiment. Referring to the drawing, the first application 21 of the mobile device 20 may receive a sound wave signal including a sound wave ID, and may extract the sound wave ID from the received sound wave signal. The first application 21 may determine whether the extracted sound wave ID is the sound wave ID related to the first application.

In the third embodiment, it is assumed that the mobile device 20 does not have mapping information, and each application can identify only the sound wave ID related to themselves and cannot identify sound wave IDs related to other applications. In an embodiment, when the first application 21 determines that the extracted sound wave ID is not the sound wave ID that the first application should process, the first application 21 transmits the sound wave ID to the server 30.

In the third embodiment, the server 30 stores mapping information 36. The mapping information 36 includes a plurality of sound wave IDs and app IDs related to the respective sound wave IDs. Additionally, the mapping information 36 may further include content information related to the respective sound wave IDs. The mapping information 36 may be stored in the server 30 or in a local database that is accessible by the server 30. In an embodiment, the mapping information 36 may be stored in the form of a lookup table or a database.

When the server 30 receives the sound wave ID, the server obtains the app ID of the second application 22 related to the corresponding sound wave ID, and content information with reference to the mapping information 36. Thereafter, the server 30 transmits the app ID and the content information to the first application 21.

When the first application 21 receives the app ID and the content information, the first application 21 may transmit the content information to the second application 22. In another embodiment, the first application 21 may transmit the sound wave ID and the content information to the second application 22. Thereafter, the second application 22 may output the received content information through the display or the speaker of the mobile device 20, for example. The method for transmitting data between applications and the meaning of the content information have been described with reference to FIG. 2, and thus a description thereof is omitted.

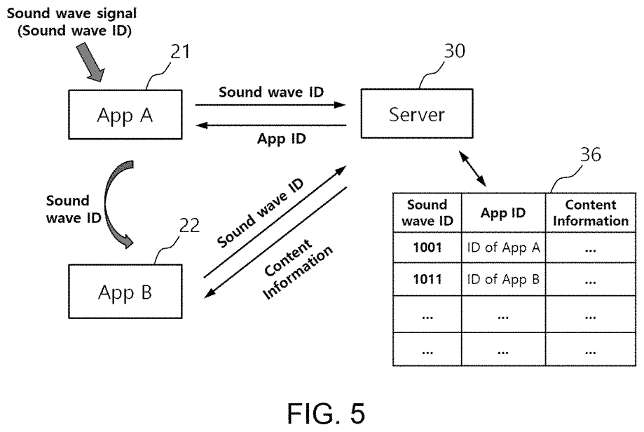

FIG. 5 illustrates an operation of receiving and processing a sound wave of an application according to a fourth embodiment. Referring to the drawing, the first application 21 of the mobile device 20 receives a sound wave signal including a sound wave ID, and extracts the sound wave ID from the received sound wave signal. The first application 21 determines whether the extracted sound wave ID is the sound wave ID related to the first application.

Similarly to the third embodiment, it is assumed in the fourth embodiment that the mobile device 20 does not have mapping information, and each application can identify only the sound wave ID related to themselves and cannot identify sound wave IDs related to other applications. Accordingly, when the first application 21 determines that the extracted sound wave ID is not the sound wave ID that the first application should process, the first application 21 transmits the sound wave ID to the server 30.

In the fourth embodiment, the server 30 stores mapping information 36. The mapping information 36 includes a plurality of sound wave IDs and app IDs related to the respective sound wave IDs. Additionally, the mapping information 36 may further include content information related to the respective sound wave IDs. The mapping information 36 may be stored in the server 30 or in a local database that is accessible by the server 30. In an embodiment, the mapping information 36 may be stored in the form of a lookup table or a database.

When the server 30 receives the sound wave ID, the server obtains the app ID of the second application 22 related to the corresponding sound wave ID with reference to the mapping information 36, and transmits the app ID to the first application 21.

When the first application 21 receives the app ID of the second application 22, the first application 21 may transmit the sound wave ID to the second application 22. The second application 22 transmits the received sound wave ID to the server 30. When the server 30 receives the sound wave ID from the second application 22, the server may transmit content information related to the sound wave ID to the second application 22.

In an alternative embodiment, the content information may be stored in another external device (referred to as a “second server”) instead of the server 30. In this case, when the second application 22 receives the sound wave ID from the first application 21, the second application may transmit the sound wave ID to the second server and may receive the content information corresponding to the sound wave ID from the second server.

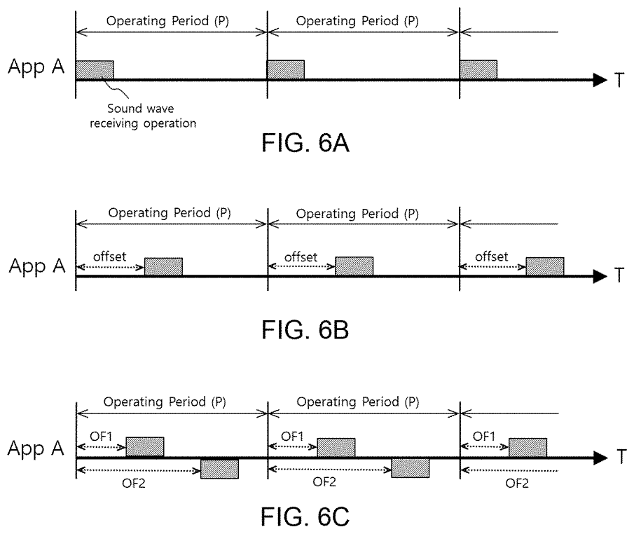

Hereinafter, an exemplary configuration for adjusting sound wave receiving operations between applications will be described with reference to FIGS. 6A to 9.

FIGS. 6A to 6C are views provided to explain a sound wave receiving operating period of an application according to an embodiment. In FIGS. 6A to 6C, the first application App A 21 will be described by way of an example for convenience of explanation. However, it will be understood that the sound wave receiving operation described below is applied to other applications such as the second application 22, etc. in the same way or similarly.

Referring to FIG. 6A, the first application 21 in an embodiment may perform a sound wave receiving operation a single time during a predetermined operating period P. The operating period P may be set when the application 21 is installed in the mobile device 20, and may be changed by updating of the application or user setting.

The sound wave receiving operation refers to an operation of receiving a sound wave signal by the mobile device 20. For example, the sound wave receiving operation may include an operation of activating, by the mobile device 20, hardware and/or software resources such as a microphone, an analogue-digital converter (ADC), a sound wave signal processor, etc. to receive a sound wave, and an operation of, when the sound wave signal is received, extracting a sound wave ID from the sound wave signal by using these resources.

Referring to FIG. 6B, in another embodiment, the first application 21 may perform the sound wave receiving operation a single time during the predetermined operating period P, but the sound wave receiving operation may be performed after a predetermined offset from a start time of the operating period P. The operating period P and the offset may be set when the application 21 is installed in the mobile device 20, and may be changed by updating of the application or user setting.

Referring to FIG. 6C, in still another embodiment, the first application 21 may perform the sound wave receiving operations multiple times during the predetermined operating period P, but the respective sound wave receiving operations within the operating period P may be performed after respective predetermined offsets from the start time of the operating period P. As shown in the drawings, the sound wave receiving operation is performed two times during each operating period P, and the first sound wave receiving operation may be performed after a first offset OF1 from the start time of the operating period P, and the second sound wave receiving operation may be performed after a second offset OF2. The operating period P and the offsets OF1, OF2 may be set when the application 21 is installed in the mobile device 20, and may be changed by updating of the application or user setting.

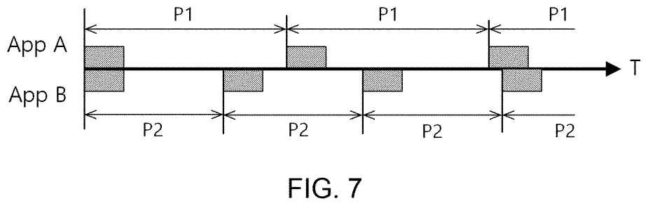

Hereinafter, a method for adjusting sound wave receiving operations between applications will be described with reference to FIGS. 7 to 9. For convenience of explanation, adjustment of operations between two applications App A and App B in the mobile device 20 will be described by way of an example. However, it will be understood that adjustment of operations can be applied to three or more applications.

FIG. 7 illustrates a method for adjusting sound wave receiving operations between applications according to an embodiment. Referring to the drawing, the first application App A 21 may perform a sound wave receiving operation a single time during a first operating period P1, and the second application App B 22 may perform a sound wave receiving operation a single time during a second operating period P2. According to a specific embodiment of the present disclosure, the first operating period P1 and the second operating period P2 may be the same as each other or may be different from each other. In the illustrated embodiment, it is assumed that the first operating period P and the second operating period P have different values, and offsets of the sound wave receiving operations of the first and second applications are 0.

In addition, it is assumed that first start times the first operating period P1 and the second operating period P2 are synchronized with each other. To synchronize some operating periods between two or more applications, a method of setting by using an absolute time of a terminal where the applications are installed may be used. In an embodiment, since each application knows their operating periods and offsets and the time of the terminal, the applications may pre-set start time(s) of the sound wave receiving operations during one day (24 hours) in the form of a time table, with reference to the time of the terminal, when determining sound wave receiving times, and may register time information of the time table at a job schedule (for example, a job schedule of an OS) according to which some of the applications are executed at a specific time. Therefore, as shown in FIGS. 7 to 9, some of the start times of the operating periods of the two applications may be synchronized.

In an embodiment, the sound wave receiving operation of the first application 21 and the sound wave receiving operation of the second application 22 may overlap each other at least in part, or may be performed separately without overlapping each other. In some operating systems such as the Android OS, authority to use a microphone may be given only to one application. Accordingly, when the sound wave receiving operations of the two applications overlap each other under such an OS, and, for example, the first application 21 performs the sound wave receiving operation that starts first (“preceding sound wave receiving operation), the sound wave receiving operation of the second application 22 that starts later (“subsequent sound wave receiving operation”) may not be performed since the preceding sound wave receiving operation uses the microphone, although the sound wave receiving operation of the second application should be performed according to its operating period. However, as described above with reference to FIGS. 2 to 5, the first application 21 having performed the preceding sound wave receiving operation extracts a sound wave ID from a sound wave signal, and then, it is determined that the sound wave ID is a sound wave ID related to the second application 22, the first application 22 may transmit the sound wave ID and content information to the second application 22.

In addition, when the sound wave receiving operations of the first and second applications do not overlap each other and are separately performed, and for example, the sound wave ID of the sound wave signal received during the sound wave receiving operation of the first application 21 is related to the second application 22, the first application 21 may transmit the sound wave ID or content information to the second application 22. In contrast, when a sound wave ID of a sound wave signal received during the sound wave receiving operation of the second application 22 is related to the first application 21, the second application 22 may transmit the sound wave ID and content information to the first application 21.

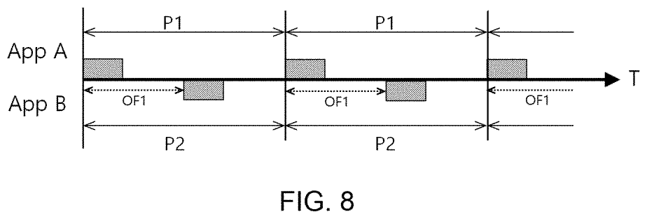

FIG. 8 illustrates a method for adjusting sound wave receiving operations between applications according to another embodiment. Referring to the drawing, the first application 21 may perform a sound wave receiving operation with an offset of 0 a single time during the first operating period P1, and the second application 22 may perform a sound wave receiving operation with an offset of OF1 (OF1 is not 0) a single time during the second operating period P2. In this case, the first operating period P1 and the second operating period P2 may be the same as each other, and start times of the operating periods may be synchronized, and the offset OF1 may be set not to make the sound wave receiving operations of the two application overlap each other.

Accordingly, in this embodiment, the sound wave receiving operation of the first application 21 and the sound wave receiving operation of the second application 22 do not overlap each other, and may be performed a single time, alternately, during the same period (P1=P2). That is, when a plurality of applications are installed in the mobile device 20, the applications may perform sound wave receiving operations without overlapping each other, by adjusting operating periods and offsets of the sound wave receiving operations of the applications.

In an embodiment, the operating periods and the offset of the sound wave receiving operations of the respective applications may be adjusted through mutual communication between the applications in the mobile device 20. Alternatively, when the mobile device 20 transmits information regarding the applications installed in the mobile device 20 and performing the sound wave receiving operations to the server 30, the server 30 may set the operating periods and the offsets of the respective application not to make the sound wave receiving operations overlap each other, and may transmit the set information to the respective applications.

When the sound wave receiving operations of the first and second applications are performed alternately, and for example, the sound wave ID of the sound wave signal received during the sound wave receiving operation of the first application 21 is related to the second application 22, the first application 21 may transmit the sound wave ID or content information to the second application 22. In contrast, when the sound wave ID of the sound wave signal received during the sound wave receiving operation of the second application 22 is related to the first application 21, the second application 22 may transmit the sound wave ID or content information to the first application 21.

Accordingly, the first application 21 may have the same effect as when the first application 21 performs the sound wave receiving operation two times during one operating period P1, and also, the second application 22 may have the same effect as when the second application 22 performs the sound wave receiving operation two times during one operating period P2. Therefore, when the sound wave receiving operations are performed alternately during one operating period and the two applications are configured to transmit sound wave IDs to each other, there is an effect that the probability of receiving a sound wave in each application can be enhanced.

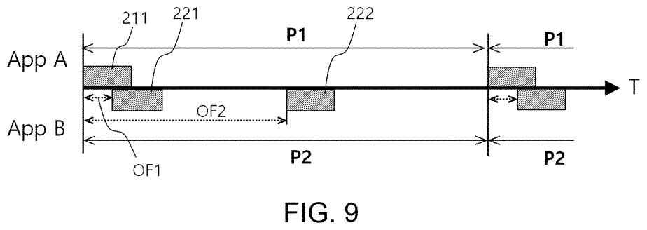

FIG. 9 illustrates a method for adjusting sound wave receiving operations between applications according to still another embodiment. Referring to the drawing, the first application 21 may perform a sound wave receiving operation 211 with an offset of 0 a single time during the first operating period P1, and the second application 22 may perform a first sound wave receiving operation 221 with a first offset OF1 and a second sound wave receiving operation 222 with a second offset OF2 a single time, respectively, during the second operating period P2.

The first operating period P1 and the second operating period P2 may be the same as each other, and start times of the operating periods may be synchronized. The first offset OF1 may be a predetermined value, not 0, and the first offset OF1 may be set to make the sound wave receiving operation 211 of the first application 21 and the first sound wave receiving operation 221 of the second application overlap each other at least in part. The second offset OF2 of the sound wave receiving operation 222 may be a predetermined value, not 0, and may be set not to overlap with the operations 211, 221.

Accordingly, in this embodiment, the sound wave receiving operation 211 of the first application 21 and the first sound wave receiving operation 221 of the second application 221 may overlap each other in every period, and since the sound wave receiving operation 211 of the first application 21 is a preceding sound wave receiving operation which is performed early, the sound wave receiving operation 211 of the first application 21 may be performed and the first sound wave receiving operation 221 of the second application 22 may not be performed in every period. However, the second sound wave receiving operation 222 of the second application 22 may be performed in every period without interference by other applications.

When the operating periods and the offsets of the first application and the second application are set as shown in FIG. 9, the first sound wave receiving operation 221 of the second application 22 may perform the role of backing up the sound wave receiving operation 211 of the first application 21. For example, when the first application 21 is a program operating in the background, the sound wave receiving function of the first application 21 may be occasionally restricted due to the policy of an OS such as power consumption reduction. On the other hand, the second application 22 may be a program operating in the foreground and thus the sound wave receiving operations 221, 222 may not be restricted by the OS. In this case, even when the sound wave receiving operation 211 of the first application 21 is not performed, the sound wave receiving operation 221 of the second application 22 may be performed at a time overlapping the time when the sound wave receiving operation 211 should be performed. The second application 22 may receive a sound wave signal including a sound wave ID related to the first application 21 through the sound wave receiving operation 221, and may transmit the sound wave ID to the first application 21, and as a result, the sound wave receiving operation 221 of the second application 22 may perform the role of backing up the sound wave receiving operation 211 of the first application 21.

In addition, when the operating periods and the offsets are set as shown in FIG. 9, the three sound wave receiving operations 211, 221, 222 are scheduled to be performed during one operating period (P1 or P2), but in reality, only two sound wave receiving operations are performed. Therefore, from the point of view of the mobile device 20, there is an effect that power consumption can be reduced.

While embodiments of the present disclosure have been described with reference to the drawings, it will be understood by those skilled in the art that various modifications and changes can be made from the descriptions of the specification. Therefore, the scope of the present disclosure should be defined not by the embodiments described above, but by the appended claims and the equivalent to the claims.

What is claimed is:

1. A method for receiving and processing a sound wave of an application which is executed in a computing device, the method comprising:
extracting, by a first application, a sound wave ID from a sound wave signal received by the computing device;
when the sound wave ID is not a sound wave ID related to the first application, obtaining, by the first application, application identification information (“app ID”) of a second application which should receive the extracted sound wave ID; and
based on the app ID, transmitting, by the first application, the sound wave ID to the second application.

2. The method of claim 1, wherein obtaining the app ID comprises obtaining the app ID mapped onto the extracted sound wave ID, based on mapping information in which respective app IDs of a plurality of applications and sound wave IDs related to the respective applications are mapped.

3. The method of claim 2, wherein the mapping information is stored in an external server device of the computing device,
wherein obtaining the app ID comprises:
transmitting, by the first application, the extracted sound wave ID to the server device; and
receiving, by the first application, the app ID selected based on the mapping information from the server device.

4. The method of claim 1, wherein the first application is configured to perform a first sound wave receiving operation one or more times during a predetermined first operating period, and the second application is configured to perform a second sound wave receiving operation one or more times during a predetermined second operating period.

5. The method of claim 4, wherein the respective first sound wave receiving operations within the first operating period are performed after respective predetermined offset time intervals from a start time of the first operating period, and the respective second sound wave receiving operations within the second operating period are performed after respective predetermined offset time intervals from a start time of the second operating period.

6. A method for receiving and processing a sound wave of an application which is executed in a computing device, the method comprising:
extracting, by a first application, a sound wave ID from a sound wave signal received by a computing device;
when the sound wave ID is not a sound wave ID related to the first application, obtaining, by the first application, application identification information (“app ID”) of a second application which should receive the extracted sound wave ID, and content information related to the extracted sound wave ID; and
transmitting, by the first application, the content information to the second application based on the app ID.

7. The method of claim 6, wherein obtaining the app ID and the content information comprises obtaining the app ID and the content information which are mapped onto the extracted sound wave ID, based on mapping information in which respective app IDs of a plurality of applications, sound wave IDs related to the respective applications, and content information related to the respective sound wave IDs are mapped.

8. The method of claim 7, wherein the mapping information is stored in an external server device of the computing device, and
wherein obtaining the app ID and the content information comprises:
transmitting, by the first application, the extracted sound wave ID to the server device; and
receiving, by the first application, the app ID and the content information selected based on the mapping information from the server device.

9. The method of claim 6, wherein the first application is configured to perform a first sound wave receiving operation one or more times during a predetermined first operating period, and the second application is configured to perform a second sound wave receiving operation one or more times during a predetermined second operating period.

10. The method of claim 9, wherein the respective first sound wave receiving operations within the first operating period are performed after respective predetermined offset time intervals from a start time of the first operating period, and the respective second sound wave receiving operations within the second operating period are performed after respective predetermined offset time intervals from a start time of the second operating period.

11. A computer readable recording medium having a program recorded thereon to execute the method described in claim 1 in a computer.

12. A computer readable recording medium having a program recorded thereon to execute the method described in claim 6 in a computer.
